(19) United States
(12) Patent Application Publication
(10) Pub. No.: US 2026/0318178 A1
(43) Pub. Date: Oct. 15, 2026

(54) ELECTRIC FRAC VALVE AND MANIFOLD CONTROL SYSTEM

(71) Applicant: VAULT PRESSURE CONTROL, LLC, Houston, TX (US)

(72) Inventors: Travis McEvoy, Houston, TX (US); Saurabh Kajaria, Houston, TX (US)

(73) Assignee: VAULT PRESSSURE CONTROL, LLC, Houston, TX (US)

(21) Appl. No.: 19/564,587

(22) Filed: Mar. 12, 2026

Related U.S. Application Data
(60) Provisional application No. 63/786,556, filed on Apr. 10, 2025.

(51) Int. Cl. E21B 43/26; F16K 31/04

(52) U.S. Cl. CPC E21B 43/2607; F16K 31/047

(57) ABSTRACT

A system for monitoring and controlling surface completion operations may include a valve conversion assembly comprising a valve frame, motor assembly, and coupler. The system may further comprise a motor control configured to activate the motor assembly. The valve conversion assembly may connect to a valve disposed within a fracturing tree, thus allowing a user to remotely operate the valve from outside a hot work area around the fracturing tree.

### BACKGROUND

### 1. Field of Invention

This disclosure relates in general to oil and gas tools, and in particular, to systems for monitoring and controlling surface completion operations.

### 2. Description of the Prior Art

Certain oil and gas operations, such as fracturing operations, may utilize a variety of surface valves and components in order to control various downhole operations. For example, surface valves may be cycled to enable different equipment to pass into wellbores (e.g., frac balls, wireline, etc.). There may be many operations ongoing at one time at the well site, and even a particular pad, and as a result, performing each operation may be challenging. Moreover, manually operated valves may be positioned within high pressure areas, an undesirable working condition. Because oil and gas operations often utilize rented equipment, it is important that operations are conducted efficiently and that wells are not subject to large amounts of “nonproductive time” (NPT) where the well sits idle. The undesirable conditions, as well as multiple operations continuing at the same time, may increase NPT at well sites, thereby reducing profitability.

In addition, power delivery at a well site is an ongoing challenge for well site operators. Completion and stimulation operations, such as hydraulic fracturing, are often performed by drawing power from a hydraulic fracturing pump truck. Any problems with the main power source may shut down an entire well site until the power supply is repaired or replaced. This NPT compounds with the number of wells at a well site scheduled for completion and stimulation operations.

### SUMMARY

Applicant recognized the problems noted above herein and conceived and developed embodiments of systems and methods, according to the present disclosure, for operating electric powered fracturing valves and manifolds.

Various embodiments of the present disclosure include a system deployed on a well pad with multiple drilled wells ready for well completion and stimulation, for example, during hydraulic fracturing operations. The system enables discretized power and remote control of individual wells, thereby enabling deployment on a well pad with a varying quantity of wells, limited by power supply to the well pad.

Various embodiments of the system may draw power from one or more power sources, for example, an on-site generator and a fracturing pump truck, or through an existing power grid. The power may enter into a main breaker assembly that is configured to supply power to a series of secondary breakers, which are in turn configured to deliver power to individual wells at the well pad. Power delivery from the power sources to the main breaker assembly may be achieved through a high-capacity high voltage service line, and from the main breaker assembly to the secondary breaker assemblies through high-capacity high voltage service lines. Power delivery may be achieved from the secondary breaker assemblies to individual wells through service lines that transmit power to the wells at a smaller capacity than the power delivery to the main and secondary breaker assemblies.

Various embodiments of the present disclosure enable individual and remote control of valves located on the fracturing trees on the wells. As an example, these valves may include master valves or secondary valves. Many fracturing trees employ a set of master valves that control all flow to and from the wellbore, commonly including upper and lower master valves. Including multiple master valves is advantageous to well pad safety, with one of the master valves operated regularly, and, once that valve begins to show signs of needed repair or valve failure, for example, leaking, the other master valve may be employed so the other valve can be replaced. Remote valve control can be achieved through deployment of a powered motor, which may receive signals from a remote located user control panel that can selectively activate the motor on an individual fracturing trees, thereby actuating the valve. Various embodiments of the present disclosure include the conversion assembly described herein for actuation of the valves.

Remotely actuating valves on fracturing trees with discretized power is advantageous over manual actuation. For example, remote actuation removes the need for wellsite personnel to be in the hot work zone of a well site, which represents an area of heightened danger when performing work that may cause a fire, well release, or explosions. Therefore, operating valves outside of the hot work zone is desired. The embodiments shown in the present disclosure show a system that enables such remote operation of valves.

Various embodiments of the present disclosure include a system with a dedicated power source to power fracturing tree valves. This dedicated power source may be a generator, battery, capacitor, accumulator, or similar dedicated power sources. The dedicated power source powers a programmable logic controller (PLC) that, in turn, is configured to operate the individual fracturing tree valves. Importantly, the PLC is configured to actuate only one valve at a time. This is advantageous for operation of the system. This configuration provides an additional degree of safety and may enable lower power consumption by the dedicated power source, extending reserves in, for example, a battery. The dedicated power source is intended to be separate from the well site's power source, including the power source employed by the main and secondary breaker assemblies. Advantageously, this system can be used to provide a dedicated power source to a fracturing manifold system, the connection between the fracturing pump source and the fracturing trees. Fracturing manifolds enable the connection of the fracturing pump source to multiple fracturing trees, which can direct the fracturing fluid pumped to an individual well. This enables simultaneous hydraulic fracturing operations which lowers NPT on a wellsite. Through inclusion of the dedicated power source, the system can operate as a failsafe measure, which allows for actuation of the master valves or fracturing manifold in the event of a power failure without the need for manual intervention.

Various embodiments of the present disclosure may include one or more sensors associated with the assembly and/or the valve frames. For example, the sensor may be a position indicator that determines whether the valve is in an open position or a closed position. In various embodiments, the sensor may evaluate a position of the valve stem to determine whether the valve is in an open position or a closed position. Additionally, in other embodiments, the sensor may evaluate a pressure (e.g., a hydraulic pressure, a pneumatic pressure) within a chamber of the actuator to determine whether the valve is in the closed position or the open position. It should be appreciated that various sensor arrangements may be incorporated into the assembly and/or valve frame in order to monitor a position of the valve.

### BRIEF DESCRIPTION OF DRAWINGS

The present technology will be better understood on reading the following detailed description of non-limiting embodiments thereof, and on examining the accompanying drawings, in which:

FIG. 1 is a perspective view of an embodiment of an electric hydraulic fracturing valve and manifold control system, in accordance with embodiments of the present disclosure.

FIG. 2 is a schematic view of an embodiment of a frac tree with valves with a conversion assembly powered by a dedicated power source, in accordance with embodiments of the present disclosure.

FIG. 3 is a perspective view of an embodiment of a frac tree with a conversion assembly, in accordance with embodiments of the present disclosure.

FIG. 4 is a perspective view of an embodiment of a frac tree with a conversion assembly, in accordance with embodiments of the present disclosure.

FIG. 5 is a perspective view of an alternate embodiment of a frac tree conversion assembly.

FIG. 6 is a cross-sectional view of the alternate embodiment shown in FIG. 5.

FIG. 7 is a schematic view of a frac tree with valves connected to the conversion assembly shown in FIG. 5.

FIG. 8 is a perspective view of an embodiment of a frac tree with a conversion assembly, in accordance with embodiments of the present disclosure.

FIG. 9 is a perspective view of an embodiment of a control panel, in accordance with embodiments of the present disclosure.

FIG. 10 is a perspective view of an embodiment of a control unit, in accordance with embodiments of the present disclosure.

FIG. 11 is a perspective view of an embodiment of a control unit, in accordance with embodiments of the present disclosure.

FIG. 12 is a perspective view of an alternate embodiment of a control unit.

FIG. 13 is a perspective view of an interior of the control unit shown in FIG. 12.

FIG. 14A-14C are graphs showing a travel profile of an exemplary valve.

FIG. 15 is a schematic view of a pad at a well site with a plurality of frac trees comprising valves connected to the conversion assembly shown in FIG. 5 and controlled by the control unit shown in FIG. 12.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

Embodiments of the present disclosure are directed toward, among other things, improving efficiency of fracturing operations. For example, fracturing operations may be approximately 60 percent efficient, thereby costing operators significant amounts of money in order to complete operations. One problem stems from having multiple vendors on site performing a variety of different tasks, and as a result, non-productive time (NPT) may be difficult to track for all of the vendors. This is a significant problem, as an hour of NPT may cost operators approximately $10,000. Accordingly, it is important for operators to be able to identify and track NPT to develop solutions. Furthermore, safety is important at the well site. Fracturing operations may be conducted in harsh environments under high pressures, and as a result, continuous monitoring of valve positions and wellbore pressure may enable safer operations.

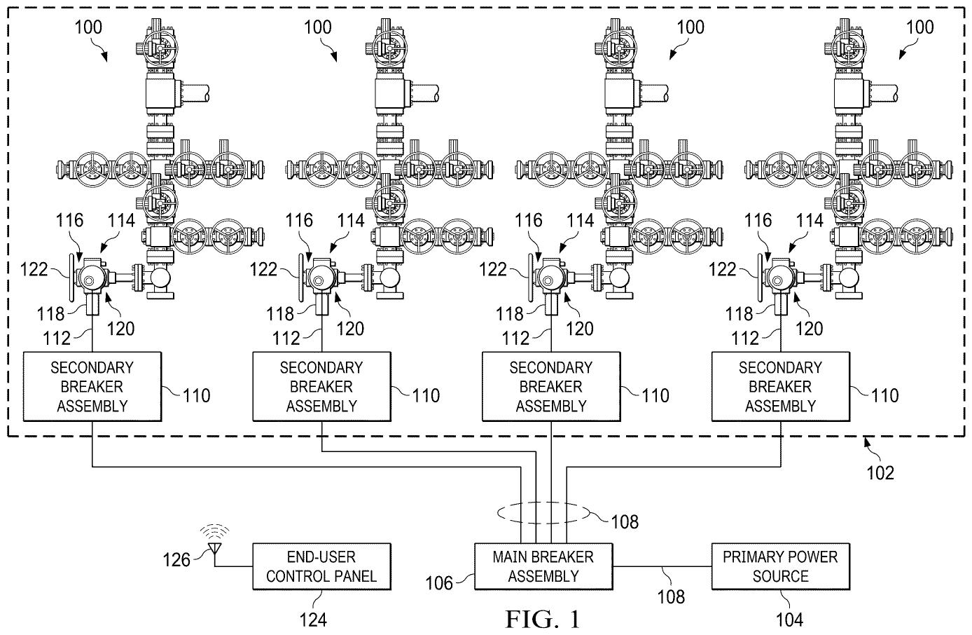

FIG. 1 illustrates an embodiment of an electric hydraulic fracturing valve and manifold control system. While not illustrated in FIGS. 1-8 for simplicity, the fracturing tree 100 may be coupled to a wellbore formed in an underground formation. Furthermore, the well site may include additional equipment, which is not pictured, such as various piping arrangement, fracturing pumps, sand loaders, and the like. During hydraulic fracturing operations, high pressure fluids, which may be slurry mixtures of components such as liquids and abrasives, may be injected into the wellbore, through fracturing tree 100, at high pressures. The high pressures crack the formation, thereby forming fissures extending into potentially hydrocarbon producing zones. The abrasives may remain in the fissures after the fluid is removed from the wellbore, thereby propping open the fissures to facilitate hydrocarbon flow.

At a wellsite, a perimeter where hot work, including work with open flames and work likely to cause an explosion, is prohibited. This hot work area 102 represents a zone of danger for personnel, and it is advantageous to reduce the amount of personnel exposure to hot work area 102. In this embodiment, the wellsite has four fracturing trees 100, but it is expressly contemplated that the described system can be tailored to an individual wellsite's configuration of wells.

The system is powered by a primary power source 104. It is contemplated that primary power source 104 may be a conventional power grid or generated on site (e.g., a generator, battery, capacitor, hydraulic, or similar). Primary power source 104 supplies power to a main breaker assembly 106 by high voltage service line 108, which establishes an electric connection. In this embodiment, primary power source 104 and main breaker assembly 106 are located outside of hot work area 102. This configuration increases safety by removing potential sources of failure from hot work area 102. It is contemplated that main breaker assembly 106 may be in hot work area 102.

Main breaker assembly 106 includes an array of fusible disconnects, which are configured to electrically connect and supply the amount of power required by equipment located downstream in the system through electrically connecting the equipment to the power source. To supply power to the fracturing tree equipment, high voltage service lines 108 electrically connect the main breaker assembly 106 to a set of secondary breaker assemblies 110. Advantageously, this configuration allows for individual control of downstream fracturing tree equipment, reducing NPT by being able to isolate individual wells, rather than requiring NPT on all wells in a well pad. While FIG. 1 depicts that each fracturing tree 100 has a corresponding secondary breaker assembly 110, it is contemplated that a secondary breaker assembly 110 may be used to power downstream equipment on multiple fracturing trees 100. This alternative configuration may be used when fewer secondary breaker assemblies 110 than fracturing trees 100 are available for deployment at a well pad.

Downstream fracturing tree equipment receives power from secondary breaker assembly 110 through a secondary service line 112, which is configured to deliver the power requirements of the downstream fracturing tree equipment and establishes an electric connection between secondary service line 112 and the downstream fracturing tree equipment. Secondary breaker assembly 110 advantageously includes multiple breakers, corresponding to each component of downstream fracturing tree equipment requiring power, thus further enabling isolation of individual components on fracturing tree 100.

In the embodiment shown in FIG. 1, downstream fracturing tree equipment includes motor control 114 and motor assembly 116, which includes motor 118, and gearbox 120 which operate to actuate master valve 122. In this embodiment, secondary breaker assembly 110 electrically connects through secondary service line 112 to the motor control 114. Secondary service lines 112 electrically may connect individually to motor control 114 and motor assembly 116 through a quick disconnect system configured to reduce the risk of explosion.

Motor control 114 serves as the control system for motor 118, which is coupled to gearbox 120. In this embodiment, motor control 114 receives a high-voltage input from secondary breaker assembly 110 through secondary service line 112 in order to transmit a control signal to motor 118. The control signal is a low voltage output from motor control 114, which is transmitted to motor 118 through a low voltage service line (not depicted). Once motor 118 receives the control signal, motor 118 actuates gearbox 120. Gearbox 120 is coupled to master valve 122, and, when motor assembly 116 is in operation, gearbox 120 actuates master valve 122. The actuation performed by gearbox 120 is configured to open and close master valve 122. While this embodiment depicts a single valve, it is contemplated that multiple motor assemblies for multiple valves may be deployed.

Advantageously, the present system enables selective coupling and decoupling of motor control 114 and motor assembly 116 from any fracturing tree 100. Selective system decoupling allows for manual operation of master valves.

Motor control 114 receives control signals from end user control panel 124, which is located outside of hot work area 102. It is expressly contemplated that motor control 114 can transmit and receive signals wirelessly or through a low voltage control line that electrically connects to the secondary breaker assembly, which electrically connects to end user control panel 124. End user control panel 124 may use this connection to send and receive control signals to and from motor control 114. In this embodiment, end user control panel 124 transmits a control signal to motor control 114 wirelessly through antennas 126. End user control panel 124 is configured to control the individual motor controls 114. While this embodiment employs one end user control panel 124, it is contemplated that multiple end user control panels to control different fracturing trees may be used.

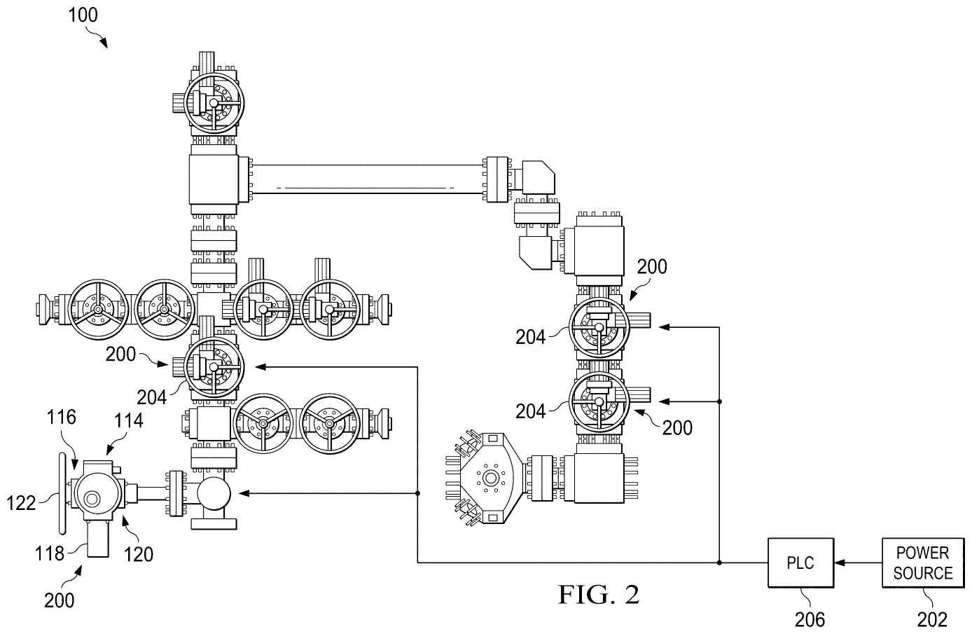

FIG. 2 depicts fracturing tree 100 employing valves 200 powered by dedicated power source 202. Advantageously, this embodiment provides dedicated power source 202 separate from primary power source 104 to enable valve actuation without dependence on primary power source 104. Generally, current systems to power well sites and valves rely on power supplied from a fracturing pump truck. In the event this power source fails, well site personnel must manually shut down a well in case of emergency, which exposes the personnel to the hot work area 102 and potential other hazards. By using dedicated power source 202, this embodiment provides a failsafe to automatically shut down a well without exposure of personnel to hazards. It is contemplated that dedicated power source 202 may be a fueled system (e.g., diesel generator, etc.), stored power system (e.g., battery storage system, capacitor system, accumulator, compressed air vessels, etc.), or electricity generating system (e.g., wind turbines, solar panels, etc.). In the embodiment of FIG. 1, primary power source 104 may comprise a dedicated power source 202.

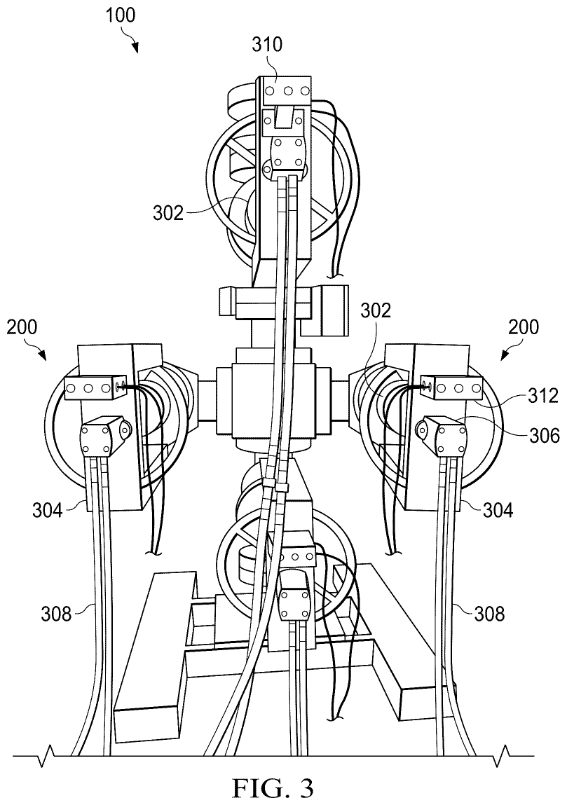

In the embodiment of FIG. 2, master valve 122 and secondary valves 204 may be converted to automated valves by employing the conversion kit illustrated in FIGS. 3-5, as further explained below. It is expressly contemplated that the valves operated by this system may also contain a manual override. Dedicated power source 202 is electrically connected to programmable logic control (PLC) 206. In this embodiment, PLC 206 is configured to limit power output from dedicated power source 202 to allow for actuation of only one valve, master valve 122 and/or one of secondary valves 204, at a time. This feature provides added safety, as it prevents an operator from inadvertently operating two valves at the same time. It is expressly contemplated that this embodiment can be employed on a fracturing tree manifold and used to actuate valves on a fracturing tree manifold.

In this embodiment, PLC 206 is electrically connected to master valve 122 and secondary valves 204 on a single fracturing tree 100. It is expressly contemplated that PLC 206 may be connected to valves of multiple fracturing trees. In this configuration, PLC 206 may operate one valve across multiple wells simultaneously. Advantageously, the system illustrated in FIG. 2 is contemplated to operate in parallel with the system illustrated in FIG. 1. This configuration adds a failsafe to the system disclosed in FIG. 1.

FIGS. 3-5 illustrate embodiments of a fracturing tree including a conversion assembly that convert manually operated valves into remotely controllable actuated valves. The illustrated frac tree includes valves and piping components, as described above. It should be appreciated that the frac tree may include more components than those illustrated herein, and that the illustration frac tree is for example purposes only and is not intended to be limiting as to the only components that may be utilized with the frac tree. It is expressly contemplated that this conversion may be employed to facilitate automatic actuation of the valves in FIGS. 1 and 2.

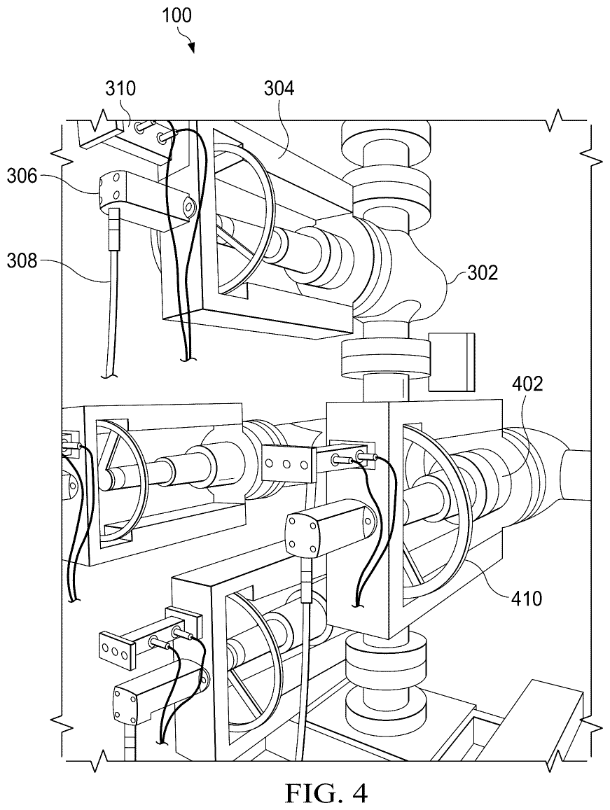

As illustrated, the conversion assembly includes valve frames that couple directly to the valves of the frac tree. The valve frames in the illustrated embodiment are coupled to the fasteners of the valve bonnet, however it should be appreciated that the valve frames may be otherwise coupled to the valves. The valve frames include an actuation element that couples to the stem for driving movement of the valves between an open position and a closed position. In the embodiment illustrated in FIG. 4, the valve frame engages hand wheels of the valves. The actuation element may be hydraulically driven, for example via hydraulic fluid pumped via hoses, as illustrated. Additionally, in various embodiments, the actuation element may be pneumatic, electric, or the like.

The valve frame further includes a sensor to evaluate a position of the valve. The position may be related to whether the valve is open, whether the valve is closed, or some condition in between (e.g., how much flow is enabled through the valve). The valve frame further includes a pressure transducer, which may determine a pressure within the wellbore or some other location of the well and/or frac tree. As noted above, the pressure may be indicative of an operation conducted via the frac tree. Alternatively, rather than a sensor, operation of the valve may be controlled using a variable frequency drive, as further discussed below.

FIG. 3 is an isometric view of an embodiment of a fracturing tree 100, which may be arranged at a well site during a fracturing operation. In various embodiments, the fracturing tree 100 may include valves 302, among other components, that regulate flow of fluid into and out of the wellbore. For example, certain valves may be moved between closed positions and open positions in order to direct fluids through the wellbore. In various embodiments, the valves may be operational via manual controls, such as hand wheels. These control systems, however, may be undesirable when the fracturing tree 100 is exposed to high pressures because of potential safety concerns with having operators within a zone of pressure formed around the fracturing tree 100. Additionally, including various meters and sensors at the fracturing tree 100 faces similar problems because operators may have difficulty reading the sensors without getting close, which as noted above, is undesirable in high pressure applications.

Embodiments of the present disclosure included conversion assemblies 400 that may be utilized to convert manually operated valves 302 into remotely operated valves. Additionally, in various embodiments, the conversion assemblies 400 may further be utilized to convert actuated valves into valves actuated by a different mechanism (e.g., convert a pneumatic actuator into a hydraulic actuator). In certain embodiments, the conversion assemblies 400 include a valve frame 304 for coupling to the valves 302. For example, the valve frame 304 may be coupled to a body of the valve 302, thereby securing the conversion assembly 400 to the valve 302. The illustrated conversion assemblies 400 further include an actuator element 306, which may be a remotely-actuatable element, such as a hydraulic actuator, a pneumatic actuator, an electrical actuator, or the like. The actuator element 306 may couple to a valve stem or a manual operator, which may then drive movement of the valve stem between an open position and a closed position. In this manner, the conversion assembly may be used in order to adjust operation of the valves 302.

In various embodiments, one or more flow lines 308 are utilized to provide motive power to the illustrated actuator elements 306. For example, the flow line 308 may enable hydraulic fluid to enter and exit a chamber of the actuator element 306, thereby driving movement of the valve stem to adjust a position of the valve. It should be appreciated that the flow line 308 are for illustrative purposes only and that other systems and methods may be incorporated to provide motive power to the actuator elements 306. Furthermore, the relative location of the flow line 308 is also for illustrative purposes.

One or more sensors may be incorporated into the conversion assembly 400 in order to facilitate operation of the monitoring system, as described above and later herein. The sensors may obtain the same or different information for each valve 302 and/or for the frac tree 100. For example, a first sensor 310 may correspond to a pressure sensor that receives a signal indicative of a pressure within the wellbore, within the frac tree 100, within a leg of the frac tree 100, or a combination thereof. For example, the pressure sensor may be a pressure transducer that is exposed to a pressure within the frac tree 100 and/or the wellbore. In various embodiments, the pressure sensor 310 may enable monitoring of stages of the fracturing operation, as described below, as different stages may be indicative of different operating pressures.

Further illustrated in FIG. 3 is a second sensor 312, which may correspond to a position sensor for the conversion assembly 400, and therefore for the valve 302. For example, the second sensor 312 may monitor a position of the valve stem, which may be correlated to a closed position for the valve, an open position for the valve, or any number of intermediate positions for the valve. As a result, flow into and out of the wellbore may be monitored, which as noted above, may be correlated to different stages of the fracturing operation.

It should be appreciated that various other sensors and monitors may also be included within the frac tree 100, and that the illustrated pressure and position sensors are for illustrative purposes only. In embodiments, flow sensors may also be incorporated into the system, thereby enabling monitoring of fracturing fluid flow into and/or out of the wellbore. Additionally, pressure sensors may be associated with the motive power source for the actuator elements 306, which may also be correlated to a valve position. As will be described below, one or more of the sensors may receive and transmit information to a control system, which may utilize analytics to categorize different operations of the well site, determine a phase of the operation, and/or monitor ongoing activities, which may improve well site operations.

FIG. 4 is a perspective view of the frac tree 100 illustrating an alternative angle as compared to FIG. 3. In the illustrated embodiment, the valves 302 are manually controlled valves that include hand wheels 410 for driving movement of the valve stem. In the illustrated embodiment, the valve frames 304 couple to the valve via a bonnet 402 such that the actuator element 306 engages the valve stem and/or the hand wheel 410. In various embodiments, at least a portion of the stem may extend through the hand wheel 410, enabling direct engagement to the stem. However, in other embodiments, direct engagement with the hand wheel 410 may be preferred.

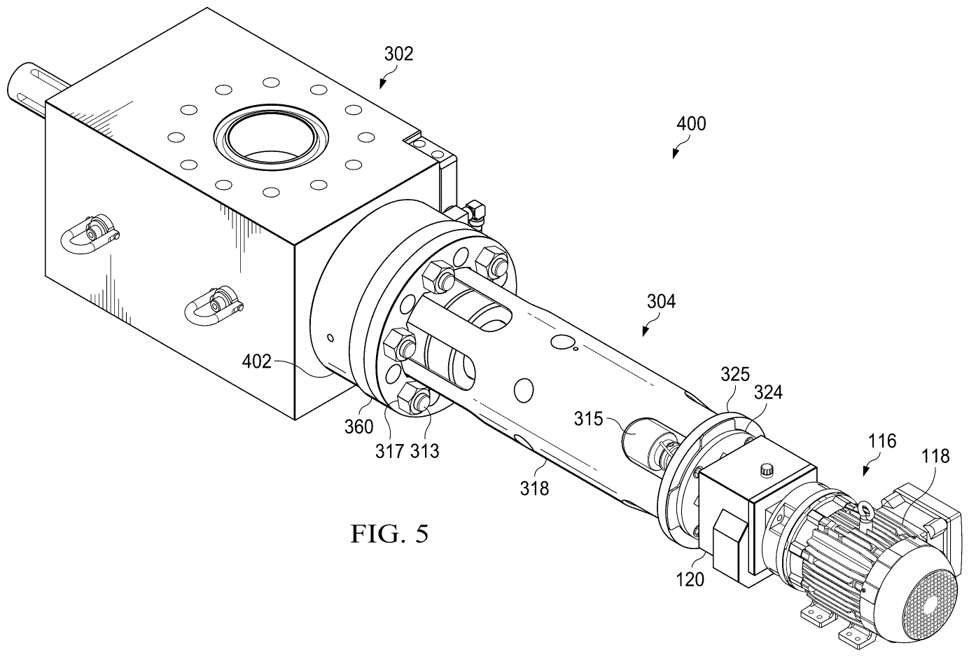

FIG. 5 is a perspective view of an alternate embodiment of conversion assembly 400. In this embodiment, conversion assembly 400 comprises valve frame 304 and spacer 360. Valve frame 304 comprises generally cylindrical housing 318 having cut-outs 315. Cut-outs 315 may be configured to allow access to components within valve frame 304 that are used to connect conversion assembly 400 to valve 302, as discussed below in further detail. Valve conversion assembly 400 further comprises upper flange 325 and lower flange 335. Lower flange 335 may connect to bonnet 402 of valve 302 using bolts 313 and nuts 317. Spacer 360 may be inserted between bonnet 402 and lower flange 335, in order to avoid potential alignment issues that might occur if lower flange 335 were attached directly to bonnet 402. Bolts 313 may be of extended length in order to extend through spacer 360.

Attached to upper flange 325 of valve frame 304 is motor assembly 116, comprising motor 118 and gearbox 120. Gearbox 120 may comprise flange 123, which connects to upper flange 325 of valve frame 304 using bolted connection 324. Gearbox 120 connects to motor 118 in a configuration well known to one of ordinary skill in the art.

Motor 118 preferably provides sufficient power to open or close valve 302 under a variety of operating conditions. As one of ordinary skill in the art will understand, the power required to open or close valve 302 will vary depending on a variety of factors, including the internal pressure within the valve. For valves that are frequently operated while exposed to high pressure, such as master valve 122 (discussed above in connection with FIGS. 1 and 2), it has been determined that a 5-horsepower electric motor should provide sufficient power to open and close the valve even when exposed to extremely high internal pressure. For other valves that are not frequently operated while exposed to high pressure, such as secondary valves 204 (discussed above in connection with FIG. 2), a smaller motor should provide sufficient power. For example, a 2-horsepower or 1-horsepower motor should provide sufficient power for these other valves. Using larger motors for valves such as the master valve and smaller motors for other secondary valves lowers the overall cost of the system and also reduces the load placed on the tree, as motors providing more horsepower generally weigh more than smaller motors. Motor assembly 116 is preferably a “Class 1, Division 1” motor (also referred to as “C1D1”), a well-known industry standard under the National Electrical Code requiring explosion-proof equipment in certain hazardous areas.

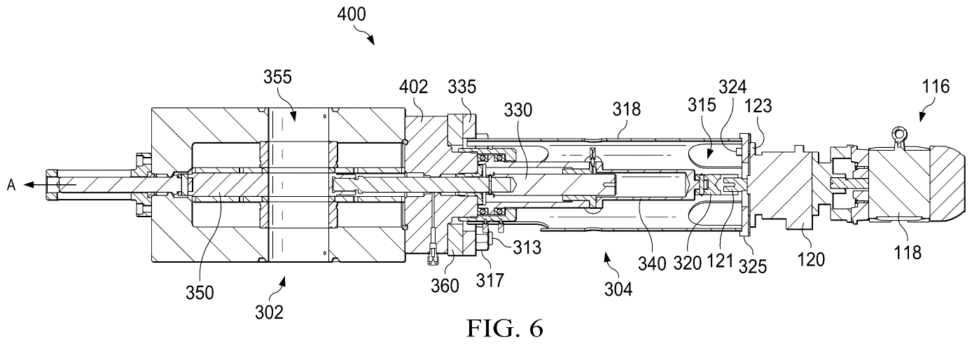

FIG. 6 is a cross-sectional view of conversion assembly 400 shown in FIG. 5. As described above, lower flange 335 is connected (through spacer 360) to valve 302, thus securing valve frame 304 to valve 302. Internally, gearbox 120 of motor assembly 116 is connected to valve 302 using coupler 320. Coupler 320 is configured to engage with the upper end of rotary ball screw 340. Coupler 320 may also comprise an opening machined to engage an output shaft 121 of gearbox 120.

As one of ordinary skill in the art will understand, rotary ball screw 340 is operatively connected to valve stem 330, such that rotation of rotary ball screw 340 causes linear movement of valve stem 330 along central axis A of valve 302. Valve stem 330 is connected to gate 350 of valve 302, such that axial movement of valve stem 330 results in corresponding axial movement of gate 350. As one of ordinary skill in the art will understand, axial movement of gate 350 is what causes valve 302 to move between a closed position in which fluid flow through bore 355 is obstructed and an open position in which fluid is allowed to flow through bore 355 (as shown in FIG. 6).

To install conversion assembly 400 as shown in FIGS. 5 and 6, the operator may first remove handwheel 410 from valve 302, thus providing access to rotary ball screw 340. The operator may then place spacer 360 adjacent to bonnet 402, such that bolts 313 extend through holes in spacer 360. The operator may then place valve frame 304 adjacent to spacer 360, such that bolts 313 extend through lower flange 335. Nuts 317 may then be threaded onto bolts 313, thus securing valve frame 304 to valve 302. Motor assembly 116 may then be connected to upper flange 325 of valve frame 304 using bolted connection 324. Coupler 320 may then be installed through cut-out 315, thus connecting gearbox 120 to rotary ball screw 340. As one of ordinary skill in the art will understand, these installation steps may performed in a different order. For example, motor assembly 116 may be connected to valve frame 304 before lower flange 335 is connected to valve 302.

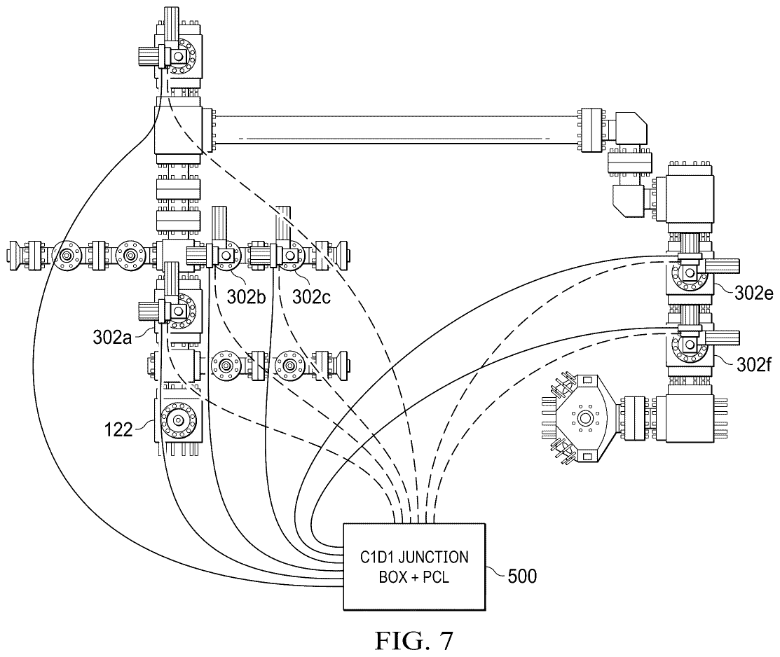

FIG. 7 is a schematic view of fracturing tree 100 with a plurality of conversion assemblies 400. In this particular embodiment, fracturing tree 100 comprises master valve 122 and six secondary valves 204. Each valve is connected to its own conversion assembly 400, thus allowing the operator to independently actuate any valve within fracturing tree 100.

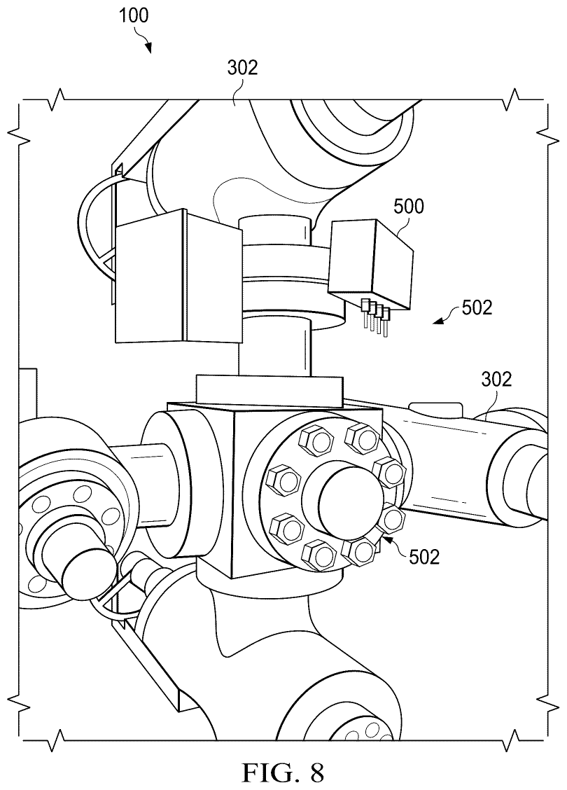

FIG. 8 is a perspective view of the frac tree 100 illustrating junction boxes 500. The junction boxes 500 may receive one or more connectors 502 coupled to the various sensors integrated into the frac tree 100. In various embodiments, the junction boxes 500 may also couple to a control system, as described below. The junction boxes 500 may also include wireless communication systems, although the illustrated embodiment features the connectors 502.

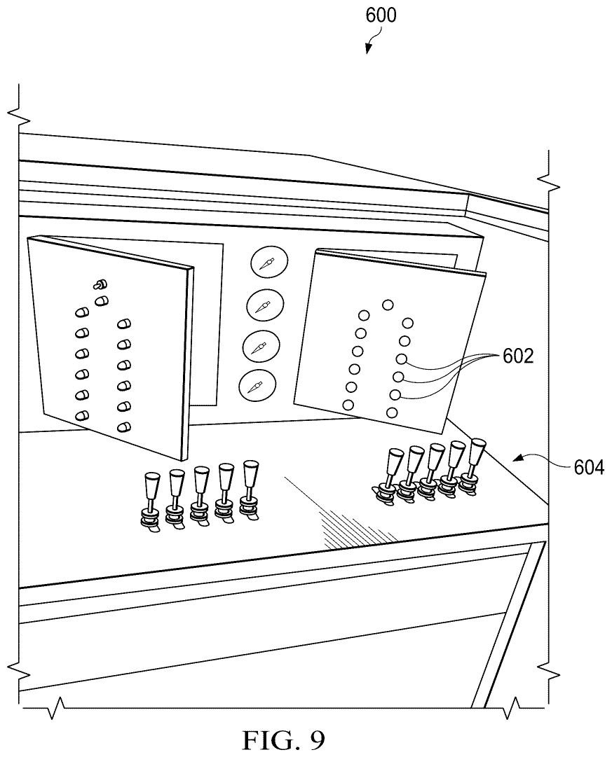

FIG. 9 is a perspective view of a control panel 600, which may be arranged proximate the frac tree 100 or at a remote location. The control panel includes indicators 602, which may illuminate to provide an indication of various components, such as valve position, pressures, and the like. Moreover, controls 604 may be integrated into the control panel 600 to direct operation of one or more components. For example, the controls 604 may send a signal to transmit fluid into the actuator elements 306, thereby driving movement of the valves 302.

It should be appreciated that the control panel 600 is provided for illustrative purposes only. In various embodiments, operation of the one or more components may be executed via digitally executing software systems, such as those executing on a personal client device. As a result, a user may interact with a display executing the software in order to drive adjustments at the wellsite, such as moving a valve between an open position and a closed position. As noted herein, the operations may be executed remotely from the wellsite, by way of example, at a location outside of a pressure zone of a wellhead.

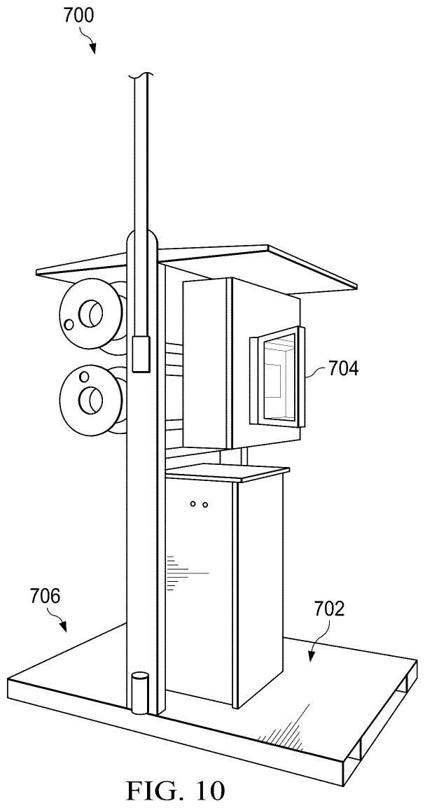

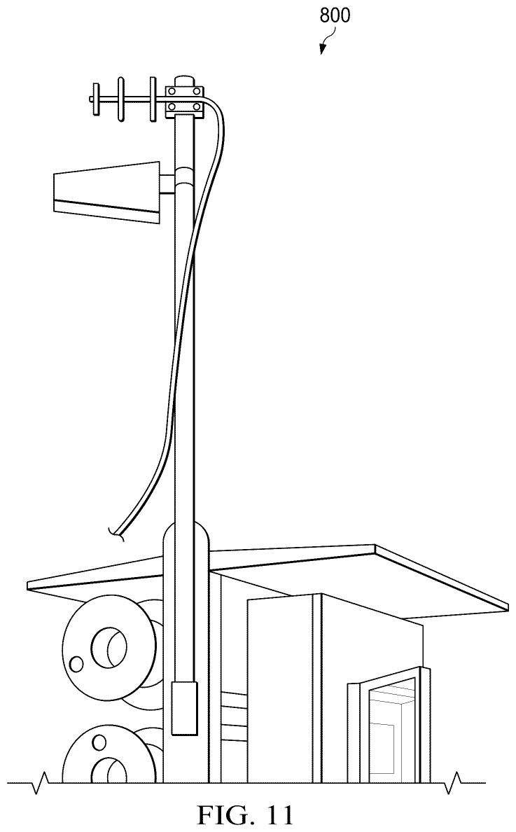

FIGS. 10-11 illustrate a remote control unit including a panel for controlling operation of the valves of the frac tree. The remote control unit may include a memory and a processor, for example as part of a computer system. The processor may execute instructions stored on the memory to conduct one or more operations. Moreover, the memory and processor may be utilized to collect and analyze information received from the one or more sensors associated with the system. As described above, in various embodiments the remote control unit may be utilized to control operation of the valves from a distance away from the frac tree, for example, outside of a pressure barrier associated with the well and/or pad. In various embodiments, the remote control unit includes a communication unit, such as a wireless transceiver, to send and receive instructions. For example, the wireless transceiver may transmit instructions to the valve actuators. However, it should be appreciated that, in other embodiments, data transmission may be conducted over wired communications. The wireless transceiver may also be used to send and receive remote messages, for example, to transmit data away from the well site for further processing.

The illustrated embodiment further includes a display, which may relay information to the user regarding pressures, valve state, and the like. The user may interact with the display to view a variety of different information, as well as to transmit instructions to the actuators at the well site. As will be described below, the display may provide real or near-real time (e.g., without significant delay) information regarding operations at the fracturing site. For example, current well configurations may be shown on the display, such as illustrating which wells are live with pressure, which valves are in open/closed/intermediate positions, and the like.

FIG. 10 is a perspective view of an embodiment of a control unit 700, which may incorporate one or more features of the control panel 600 described above. In various embodiments, the control unit 700 is configured to be moveable about the well site and between different sites, thereby increasing flexibility for its use. The illustrated control unit 700 includes a control system 702 and a display 704. The control system 702 may include a computer system including at least one processor and at least one memory unit. The processor may execute instruction stored on the memory unit and/or instructions received, for example via a communications unit 706. The communications unit may include wired or wireless communication capabilities to facilitate receipt and transmission of instructions and/or data at the well site. For example, in the illustrated embodiment various connectors 502 are coupled to the control system 702, illustrating how wired communication systems may be utilized. Moreover, a wireless communication system, which may be part of the communication unit 706, is illustrated, which may be utilized for wireless communication. Advantageously, the control unit 700 may be arranged at a location remote from (e.g., at least a specified distance away from) the frac tree 100. For example, the control unit 700 may be positioned outside of a pressure zone.

FIG. 11 is a perspective view of an embodiment of a wireless communication system 800, which may be used to send and/or receive signals at the well site. In various embodiments, software executing on the control system 702 may be hosted software, and as a result, the wireless communication system 800 may be used in order to connect to a remote server to receive the software for execution at the site. Moreover, in embodiments, the wireless communication system 800 may be used to transmit data for further processing, among other features. It should be appreciated that a variety of different wireless communication systems may be included, such as cellular communication protocols, near field communication protocols, wireless internet protocols, and the like.

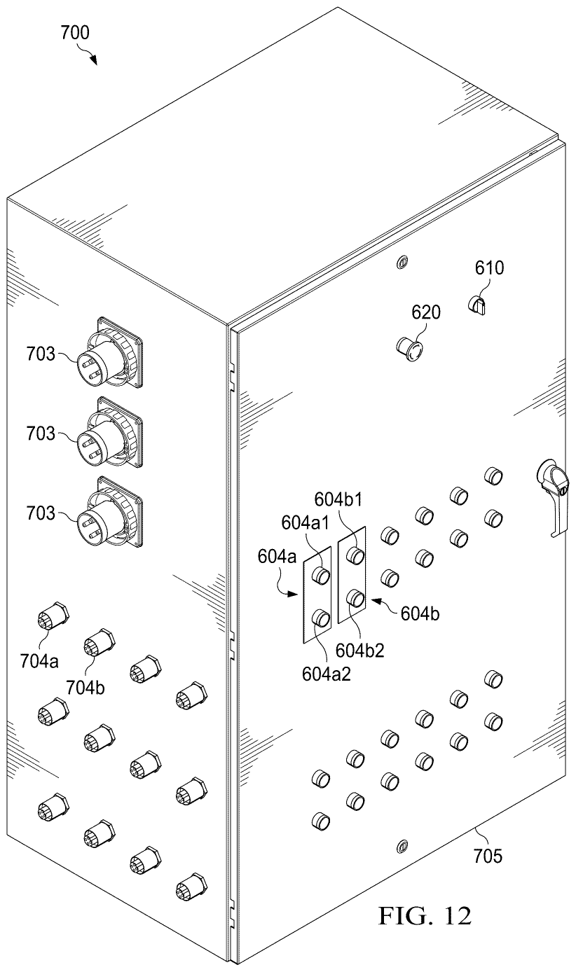

FIG. 12 shows an alternate embodiment of control unit 700 comprising housing 705. Control unit 700 may be an exemplary embodiment of end user control panel 124 discussed above. In this embodiment, controls 604 may comprise simple switches or buttons disposed on an exterior surface of housing 705. For example, control 604a may comprise a pair of buttons configured to operate a first valve 302a. Button 604a1 may be configured to open first valve 302a, while button 604a2 may be configured to close first valve 302a. Control 604b may similarly comprise a pair of buttons, 604b1 and 604b2, configured to open and close a second valve 302b. The buttons on control unit 700 may be configured to indicate the current status of each associated valve. For example, if both buttons 604a1 and 604a2 are blinking, this may indicate that conversion assembly 400 connected to valve 302a was recently powered on, and the position of gate 350 within valve 302a is therefore unknown. If button 604a1 is blinking, this may indicate that valve 302a is in the process of moving to the open position. If button 604a1 is solid, this may indicate that valve 302a is in the open position. Conversely, if button 604a2 is blinking, this may indicate that valve 302a is in the process of moving to the closed position. If button 604a2 is solid, this may indicate that valve 302a is in the closed position.

This embodiment of control unit 700 may also comprise emergency stop button 610 and/or well shutdown button 620, which may be disposed on an exterior surface of housing 705. Emergency stop button 610 may be configured to immediately interrupt power to all valves connected to control unit 700. Well shutdown button 620 may be configured to initiate a pre-programmed shutdown sequence for all valves connected to control unit 700, followed by interrupting power to all valves. In an embodiment with multiple control units 700, well shutdown button 620 may be configured to communicate the shutdown command to all wells connected to any control unit 700, such that an operator has the ability to shut down the entire wellsite by pressing a single button.

This embodiment of control unit 700 may also comprise one or more power inputs 703 and a plurality of power outputs 704a and 704b, which may be disposed on an exterior surface of housing 705. Power input 703 may provide power to control unit 700 from any suitable external power source. As discussed above, power input 703 may optionally be connected to dedicated power source 202. Power outputs 704a and 704b provide power from control unit 700 to operate motor assemblies 116 connected to, respectively, first valve 302a and second valve 302b.

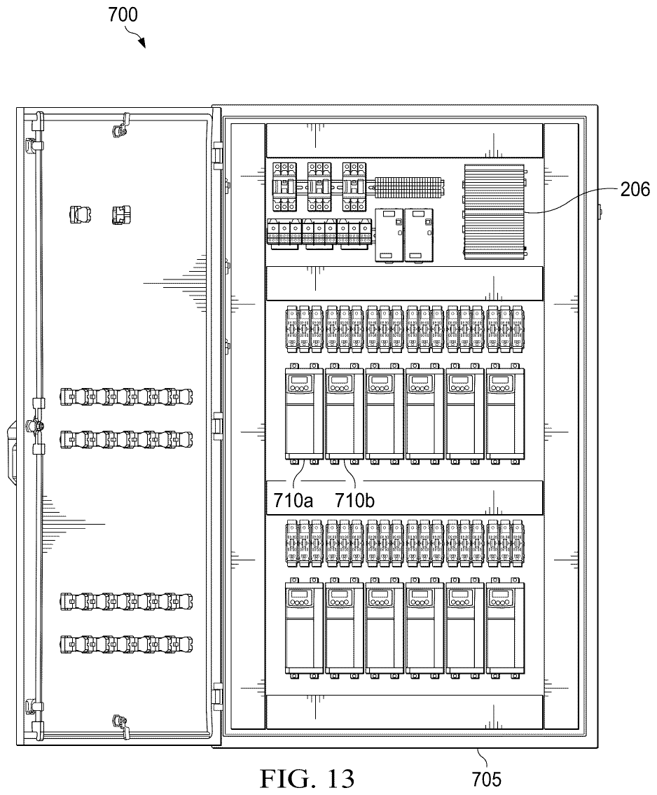

FIG. 13 shows the interior of housing 705 of control unit 700. Disposed within housing 705 are a plurality of variable frequency drives (VFDs) 710a and 710b. VFDs 710a and 710b may be an exemplary embodiment of motor control 114 discussed above. VFD 710a may be connected to motor assembly 116 on first valve 302a, while VFD 710b may be connected to motor assembly 116 on second valve 302b.

VFDs 710a and 710b may be controlled by programmable logic controller (PLC) 206. PLC 206 may be used to upload or modify the travel profile for each VFD, as discussed below in further detail. PLC 206 may also be configured to limit power outputs 704a and 704b, such that only one valve, master valve 122 and/or one of secondary valves 204, may be operated at a time. As noted above, this feature provides added safety, as it prevents an operator from inadvertently operating two valves at the same time. PLC 206 may also control the operation of the emergency stop and well shutdown functions discussed above.

Control unit 700 may also comprise an ethernet connection, allowing valves 302 to be remotely operated by a user via a laptop or other mobile computing device. Control unit 700 may also comprise an input port allowing valves 302 to be operated wirelessly, for example via wireless communication system 800.

In operation, control 604 may be used to activate VFD 710, thus causing motor assembly 116 to rotate rotary ball screw 340. As discussed above and understood by one of ordinary skill in the art, the rotation of rotary ball screw 340 will result in the axial movement of valve stem 330, thus causing valve 302 to move to the open position. Conversely, control 604 may be used to activate VFD 710 to cause motor assembly 116 to rotate rotary ball screw 340 in the opposite direction, thus causing valve 302 to move to the closed position.

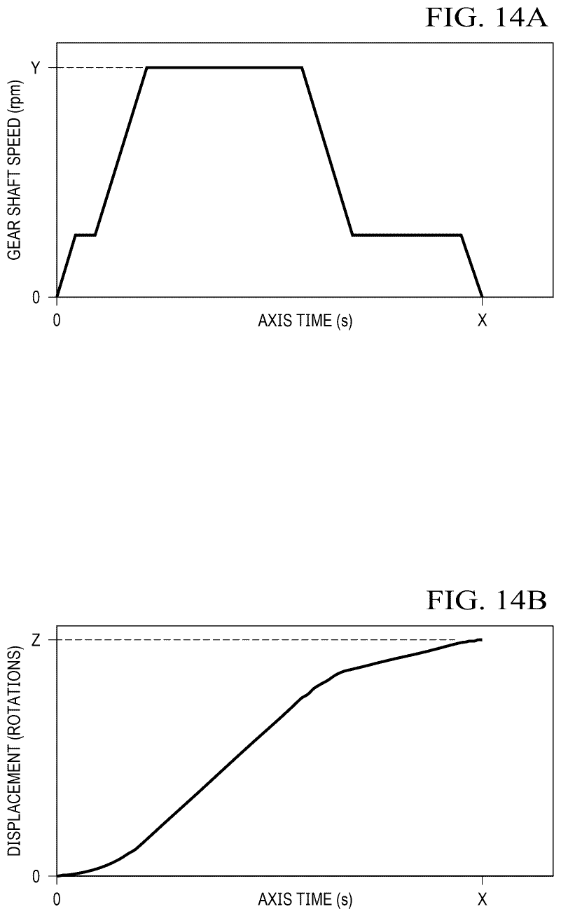

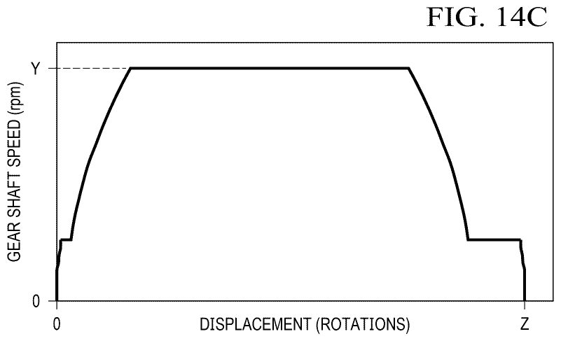

In a preferred embodiment, each VFD 710 will have one or more pre-programmed travel profiles for its associated valve 302. For example, FIG. 14A shows the travel profile for an exemplary valve 302 as function of time and gear shaft speed (in RPM), as controlled by VFD 710. As shown in FIG. 14A, a given valve 302 may take a total time X to fully open or close. Upon initial movement of gate 350, VFD 710 may cause the motor to move the gate relatively slowly. Once gate 350 has moved from its initial position, the speed of movement may accelerate up to a gear shaft speed of Y. This faster operation may continue for a period of time, after which movement of gate 350 will slow once the valve nears the open or closed position. The slower operation will continue for the final portion of the cycle, before slowing to zero at the conclusion of opening or closing.

FIG. 14B shows the travel profile of an exemplary valve as a function of time and displacement, in terms of rotation of rotary ball screw 340. Because the number of rotations (shown in FIG. 14B as Z) is directly tied to the gear shaft speed, the profile shown in FIG. 14B is essentially a different way of representing the same information reflected in FIG. 14A. In other words, gate 350 moves relatively slowly during the initial phase of operation, moves faster during an intermediate portion of the cycle, and slows down just prior to opening or closing. FIG. 14C, showing the same profile as a function of displacement (rotation of rotary ball screw 340) and gear shaft speed, is essentially a combination of FIGS. 14A and 14B.

Pre-programmed travel profiles may be useful to ensure that valve 302 moves relatively slowly upon initial opening or closing. This may be advantageous due to the large pressure fluctuations that valve 302 may experience at the initial stages of either opening or closing. Pre-programmed travel profiles may also be useful to ensure that gate 350 within valve 302 stops moving, and motor assembly 116 stops rotating rotary ball screw 340, once valve 302 has reached either the open or closed position.

In addition to the operating profile shown in FIGS. 14A-14C, VFD 710 may also be programmed to follow other travel profiles. For example, VFD 710 may follow a “homing” profile which is enacted upon the initial start-up of motor assembly 116. The homing profile may involve less current being supplied to motor assembly 116, thus resulting in a lower gear shaft speed and slower movement of gate 350. This may be desirable because, at start-up, the position of gate 350 is unknown.

As an alternative to pre-programmed travel profiles, position sensors could be used to determine the location of gate 350 within valve 302. This could include sensor 312 discussed above. Based on input from such position sensors, VFD 710 could determine when motor assembly 116 should be operated relatively slowly, when speed could be increased, and when operation should stop because valve 302 has reached either the open or closed position.

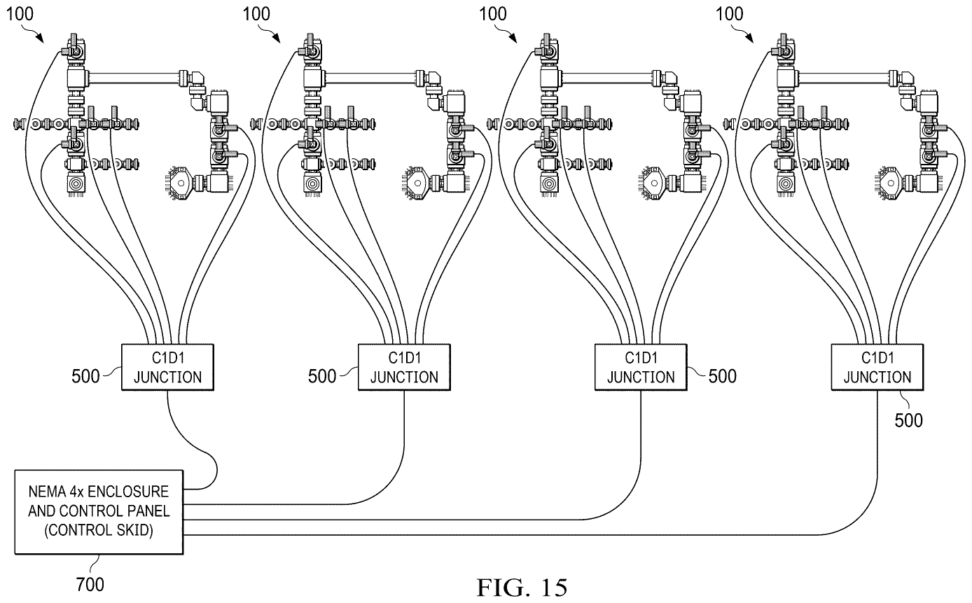

FIG. 15 shows a well pad comprising multiple fracturing trees 100, each of which is connected to control unit 700. As shown in FIG. 13, control unit 700 may be configured to include a plurality of VFDs 710, enabling a single unit to control all valves 302 on a plurality of fracturing trees 100. For example, control unit 700 may comprise 12 VFDs 710, which may be used to control two separate fracturing trees 100, each of which includes one master valve 122 and five secondary valves 204.

The end user control panel 124 discussed above in conjunction with FIG. 1 may comprise a structure similar to control panel 600, control unit 700, and/or wireless communication system 800.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A remotely operated frac valve comprising:
a valve comprising:
a throughbore;
a gate configured to selectively obstruct a flow of fluid through the throughbore;
a valve stem connected to the gate;
a rotary ball screw operatively connected to the valve stem; and
a bonnet;
a valve conversion assembly comprising:
a valve frame comprising:
a cylindrical housing;
a lower flange configured to connect to the bonnet; and
an upper flange;
a motor assembly comprising:
a motor; and
a gearbox operatively connected to the motor and comprising:
a flange configured to connect to the upper flange of the valve frame; and
an output shaft; and
a coupler configured to operatively connect the rotary ball screw to the output shaft; and
a motor control configured to activate the motor assembly.

2. The remotely operated frac valve of claim 1, further comprising a spacer configured to be disposed between the valve bonnet and the lower flange of the valve frame.

3. The remotely operated frac valve of claim 1, wherein the motor control comprises a variable frequency drive.

4. The remotely operated frac valve of claim 3, wherein the variable frequency drive is configured to operate the motor according to a first pre-programmed travel profile.

5. The remotely operated frac valve of claim 4, wherein the variable frequency drive is configured to operate the motor according to a second pre-programmed travel profile that is different from the first pre-programmed travel profile.

6. The remotely operated frac valve of claim 4, wherein the pre-programmed travel profile prevents the motor from continuing to operate after the valve has reached a position in which the gate fully obstructs the throughbore.

7. The remotely operated frac valve of claim 1, wherein the housing of the valve frame comprises a cut-out.

8. The remotely operated frac valve of claim 3, further comprising a programmable logic controller configured to control the motor control.

9. The remotely operated frac valve of claim 1, wherein the valve is located within a hot work area and the motor control is located outside the hot work area.

10. A system for remotely operating a plurality of frac valves, comprising:
a fracturing tree comprising a plurality of valves, each valve comprising:
a throughbore;
a gate configured to selectively obstruct a flow of fluid through the throughbore;
a valve stem connected to the gate;
a rotary ball screw operatively connected to the valve stem; and
a bonnet;
a valve conversion assembly connected to each valve, each valve conversion assembly comprising:
a valve frame comprising:
a cylindrical housing;
a lower flange configured to connect to the bonnet; and
an upper flange;
a motor assembly comprising:
a motor; and
a gearbox operatively connected to the motor and comprising:
a flange configured to connect to the upper flange of the valve frame; and
an output shaft; and
a coupler configured to operatively connect the rotary ball screw to the output shaft; and
a motor control configured to selectively activate the motor assembly connected to one of the plurality of valves.

11. The system of claim 10, further comprising a programmable logic controller.

12. The system of claim 11, wherein the programmable logic controller is configured to prevent the simultaneous operation of more than one motor.

13. The system of claim 10, wherein one of the plurality of valves is connected to a motor configured to provide more power than the motors connected to the others of the plurality of valves.

14. A system for remotely operating a plurality of valves on a plurality of fracturing trees, comprising:
a well pad comprising a plurality of fracturing trees, each fracturing tree comprising a plurality of valves and each valve comprising:
a throughbore;
a gate configured to selectively obstruct a flow of fluid through the throughbore;
a valve stem connected to the gate;
a rotary ball screw operatively connected to the valve stem; and
a bonnet;
a valve conversion assembly connected to each valve, each valve conversion assembly comprising:
a valve frame comprising:
a cylindrical housing;
a lower flange configured to connect to the bonnet; and
an upper flange;
a motor assembly comprising:
a motor; and
a gearbox operatively connected to the motor and comprising:
a flange configured to connect to the upper flange of the valve frame; and
an output shaft; and
a coupler configured to operatively connect the rotary ball screw to the output shaft; and
a control unit comprising:
a housing;
a plurality of motor controls disposed within the housing, each motor control configured to selectively activate the motor assembly connected to one of the plurality of valves;
a plurality of controls disposed on an exterior surface of the housing, each control configured to control one or more of the plurality of motor controls.

15. The system of claim 14, wherein one of the plurality of controls is configured to prevent activation of any motor assembly connected to any of the plurality of valves.

16. A method for converting a frac valve for remote operation, comprising the following steps:
removing a hand wheel from a rotary ball screw connected to a valve stem of the valve;
connecting to a bonnet of the valve a valve conversion assembly comprising:
a valve frame comprising:
a cylindrical housing;
a lower flange configured to connect to a bonnet of the valve; and
an upper flange;
a motor assembly comprising:
a motor; and
a gearbox operatively connected to the motor and comprising:
a flange configured to connect to the upper flange of the valve frame; and
an output shaft;
installing a coupler to operatively connect the rotary ball screw to the output shaft; and
operating a motor control to activate the motor assembly, thereby rotating the rotary ball screw and causing axial movement of the valve stem;
removing the valve conversion assembly; and
replacing the hand wheel.

17. The method of claim 16, further comprising the step of placing a spacer between the valve bonnet and the lower flange of the valve frame.

18. The method of claim 16, wherein the step of installing the coupler is performed through a cut-out in the housing of the valve frame.

19. The method of claim 16, wherein the valve is located within a hot work zone and the step of operating the motor control is performed outside the hot work zone.

20. The method of claim 16, wherein the step of operating the motor control is performed according to a pre-programmed travel profile.
